(19) United States
(12) Patent Application Publication
(10) Pub. No.: US 2017/0165996 A1
(43) Pub. Date: Jun. 15, 2017

(54) GameKitt

(71) Applicant: Michael James Brown, Holts Summit, MO (US)

(72) Inventor: Michael James Brown, Holts Summit, MO (US)

(21) Appl. No.: 14/827,295

(22) Filed: Aug. 17, 2015

(51) Int. Cl. B42D 15/00

(52) U.S. Cl. CPC B42D 15/0006; B42D 15/0086

(57) ABSTRACT

The GameKitt is a spiral bound “notebook” style flip-through with a front and back cover. It is bound on the long side (top) with horizontal content. It can be generic or team specific. The GameKitt comes with a standard pre sharpened #2 graphite pencil. The GameKitt contains a plastic transparent receptacle sleeve, a Welcome page, GameDay page, PreGame page, a Key page, Innings pages, and a PostGame page. The function of the GameKitt is to retain a detailed record of a day at the ballpark. It is intended to record all of the circumstances, conditions, personal observations and events involved with or relating to the experience of attending a professional baseball game. The purpose of the GameKitt is not only to retain a playby-play account of the game, but also to keep a more comprehensive, meaningful record of the entire experience that can later be referred to for either historic or nostalgic purposes.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The GameKitt pertains to and involves the sport of professional baseball. Specifically, it attempts to record and retain all of the actions and proceedings of an attended game, including the plays and player or manager moves as they occur during the game, as well as the surroundings, circumstances and atmospheric conditions involved in the experience of attending the game as a whole. The GameKitt contains a simple but comprehensive method of scoring a game (recording the play-by-play on-field action of a complete game), but also includes sections that prompt the recorder to record atmosphere, circumstances, notable game information and other perceived important or pertinent information as the recorder desires. While the traditional and preexisting baseball scorecard provides the ability to fully score a game, it is sometimes considered technical, messy, impersonal or “boring”. The GameKitt attempts to improve on the traditional scorecard by redesigning the scoring process to be somewhat more comprehensive and detailed while at the same time, simpler due to the exclusion of superfluous or unnecessary information recording. Included in the GameKitt is a plastic transparent sleeve designed to retain game day paraphernalia collected before, during or after the game such as ticket stub(s), receipts, stadium handouts, parking passes, team schedules, etc. The redesigned scoring process, combined with the inclusion of other game day data and personal observations, as well as the provided sleeve to retain related game or stadium paraphernalia, give the recorder a chance to keep a more comprehensive and meaningful record of the experience. The GameKitt can then be referred to later for either historic or nostalgic purposes.

### BRIEF SUMMARY OF THE INVENTION

The function of the GameKitt is to retain a detailed record of a day at the ballpark. More personal and substantive but less technical and specific than the traditional scorecard, it is intended to record all of the circumstances, conditions, personal observations and events involved with or relating to the experience of attending a professional (major or minor league) baseball game. The purpose of the GameKitt is not only to retain a play-by-play account of the game, but also to keep a more comprehensive, meaningful record of the entire experience that can later be referred to for either historic or nostalgic purposes.

### BRIEF DESCRIPTION OF THE SEVERAL VIEWS OF THE DRAWING

FIG. 1: “Stub Sleeve”. The first element of the GameKitt is a transparent, plastic sleeve which is spiral bound into the GameKitt like the rest of the pages. The sleeve is used to retain any paraphernalia obtained during the day pertaining to the game or the ball park, such as the ticket stub(s), parking pass, purchase receipts, stadium handouts, photos or other items collected as part of the overall experience of attending the game.

FIG. 2: The “Welcome” page. A welcoming statement followed by the intended function and purpose, as well as a brief instructive overview of the GameKitt is stated on this page for the benefit of the recorder.

FIG. 3: The “GameDay” page. This page includes designated areas to record pregame information and observations including: date and time, game location (stadium name, city and state or province), starting time of the game, family or acquaintances also in attendance, weather conditions, game number attended (during the current season) and seat information and rating, as well as any otherwise relevant information concerning the game (such as promotional dates, playoff implications, important home games, or otherwise momentous games for team, individual player, or even for the recorded himself or herself).

FIG. 4: The “PreGame” page. This page includes places to record the contending teams (if the GameKitt is generic), or the opposing team (if the GameKitt is home team specific), the starting lineups (including player names, field positions, batting orientation (right or left), and batting order) and team managers.

FIG. 5: The “Key” page. This page lists the simple abbreviations (consisting of 1, 2, or 3 letters) to use in the GameKitt innings pages that follow to record any possible result of, or occurrence during an at bat. Included on the Key page is a sample “inning” page and instructions on how and when to fill in the lineup positions, at bat, end of inning statistics and offensive and defensive player substitutions sections included on the innings pages.

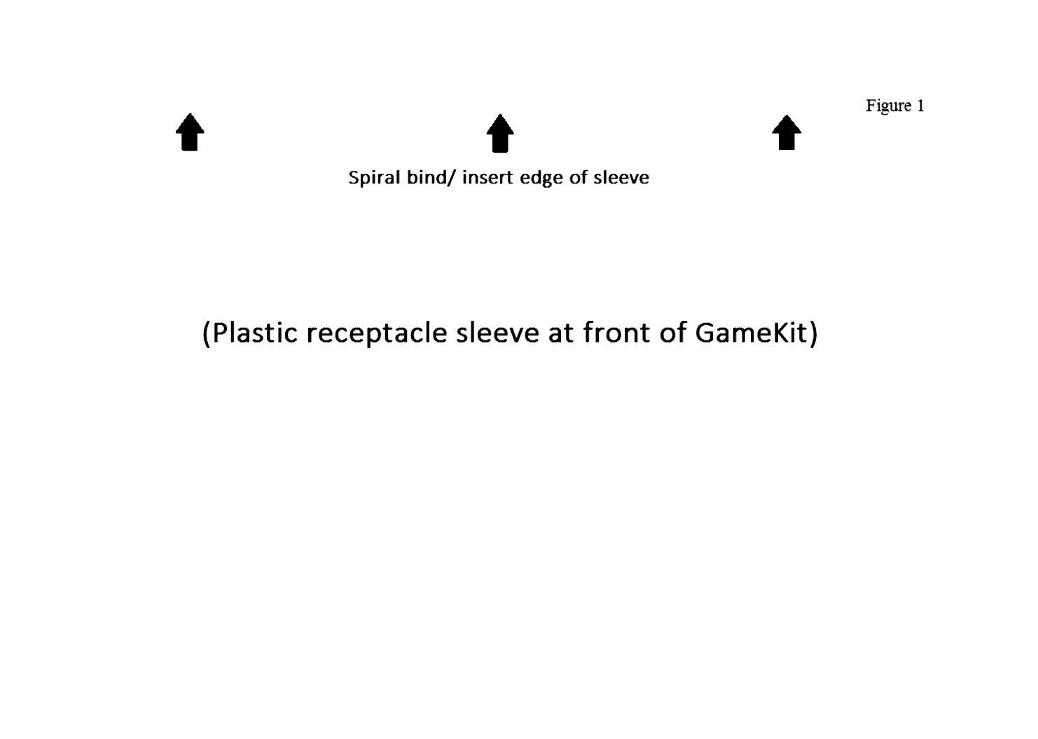

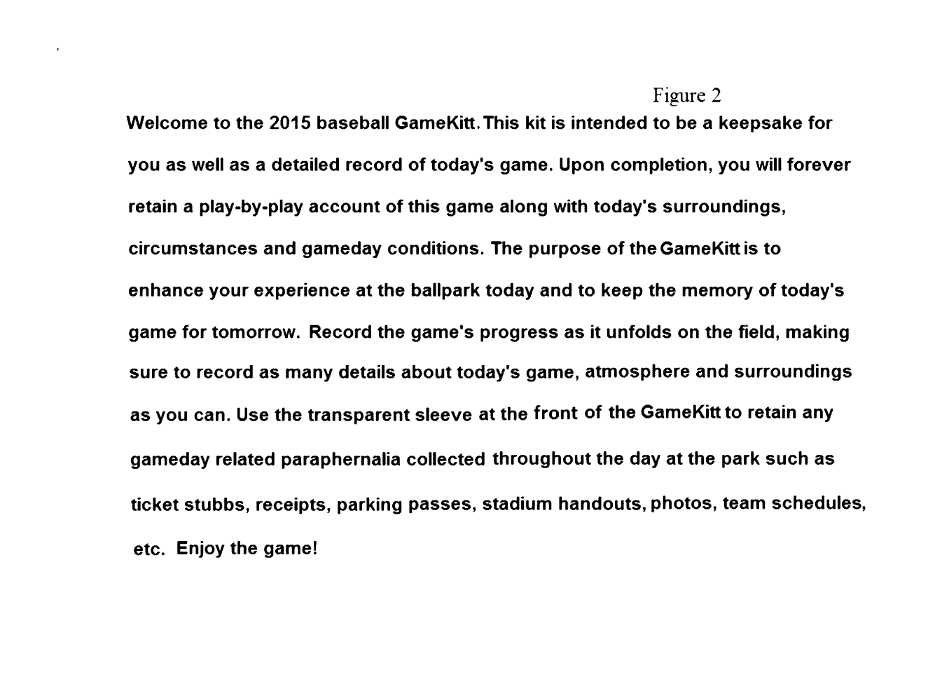

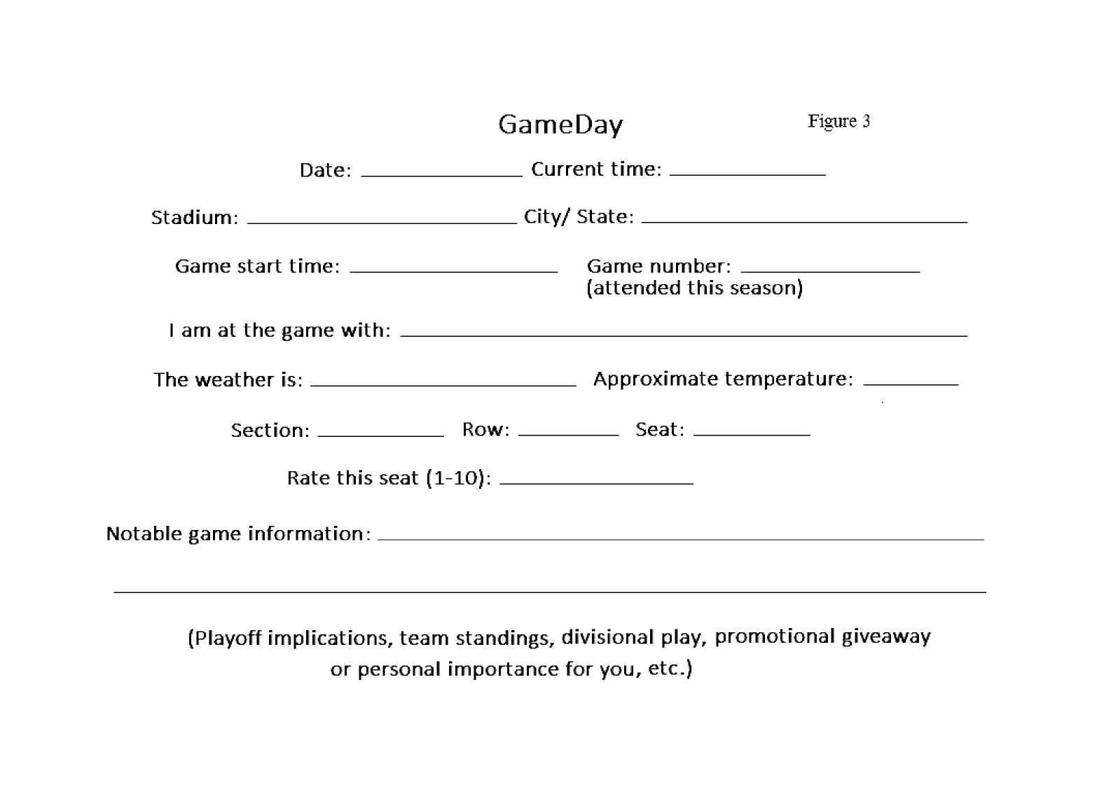

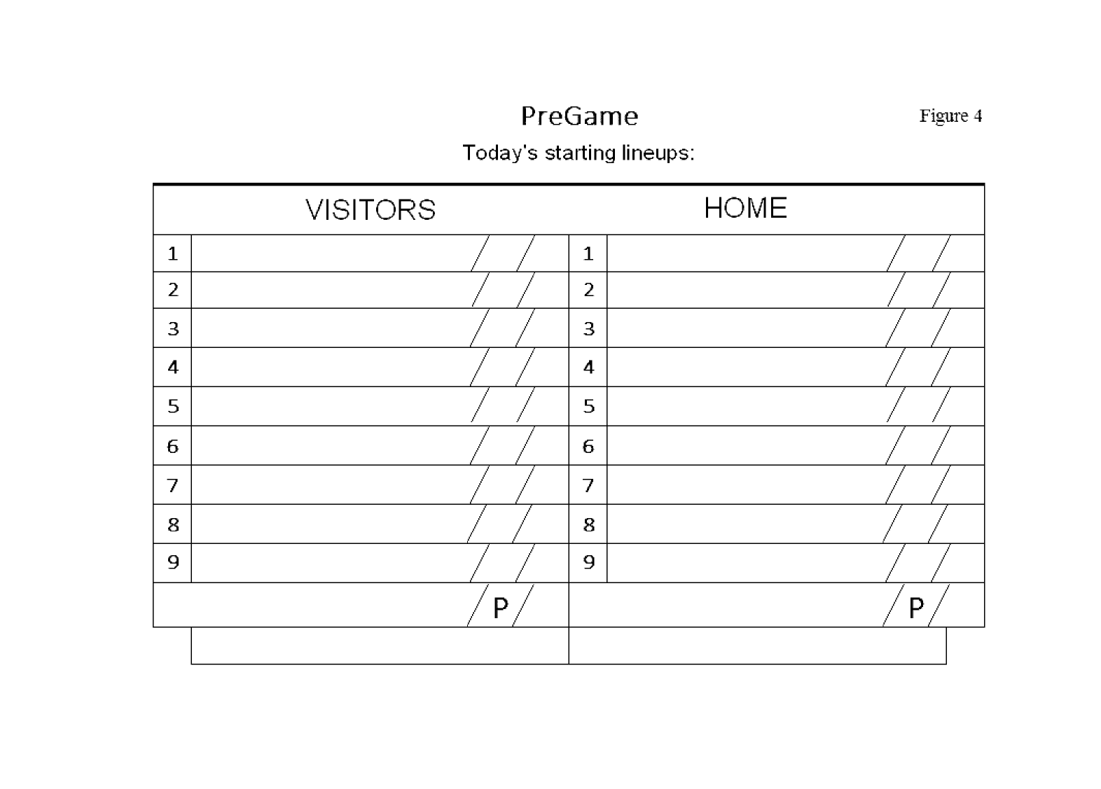

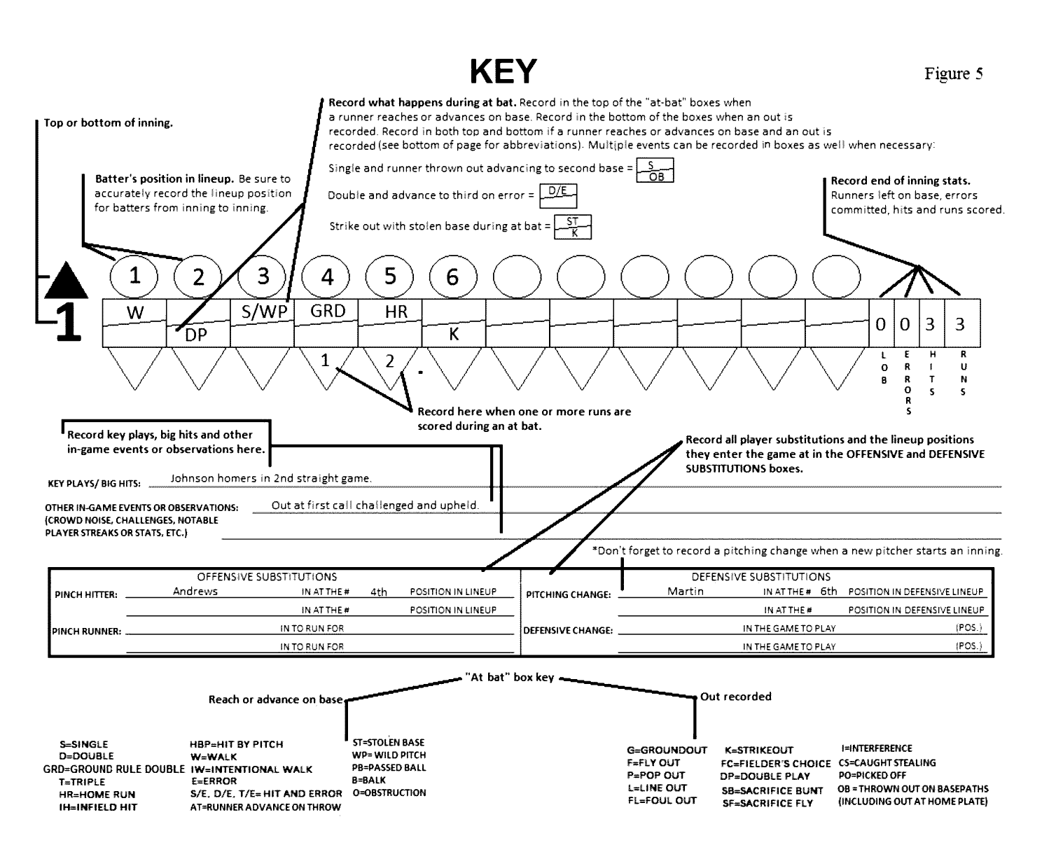

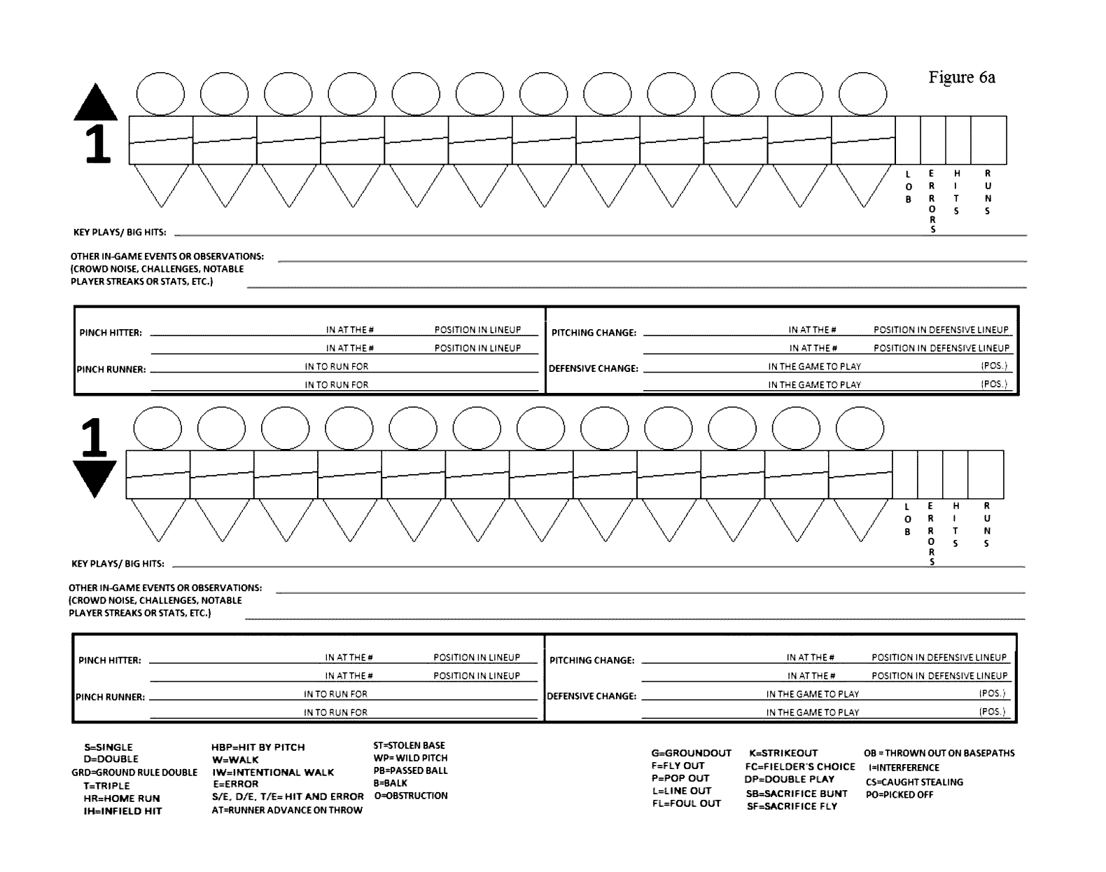

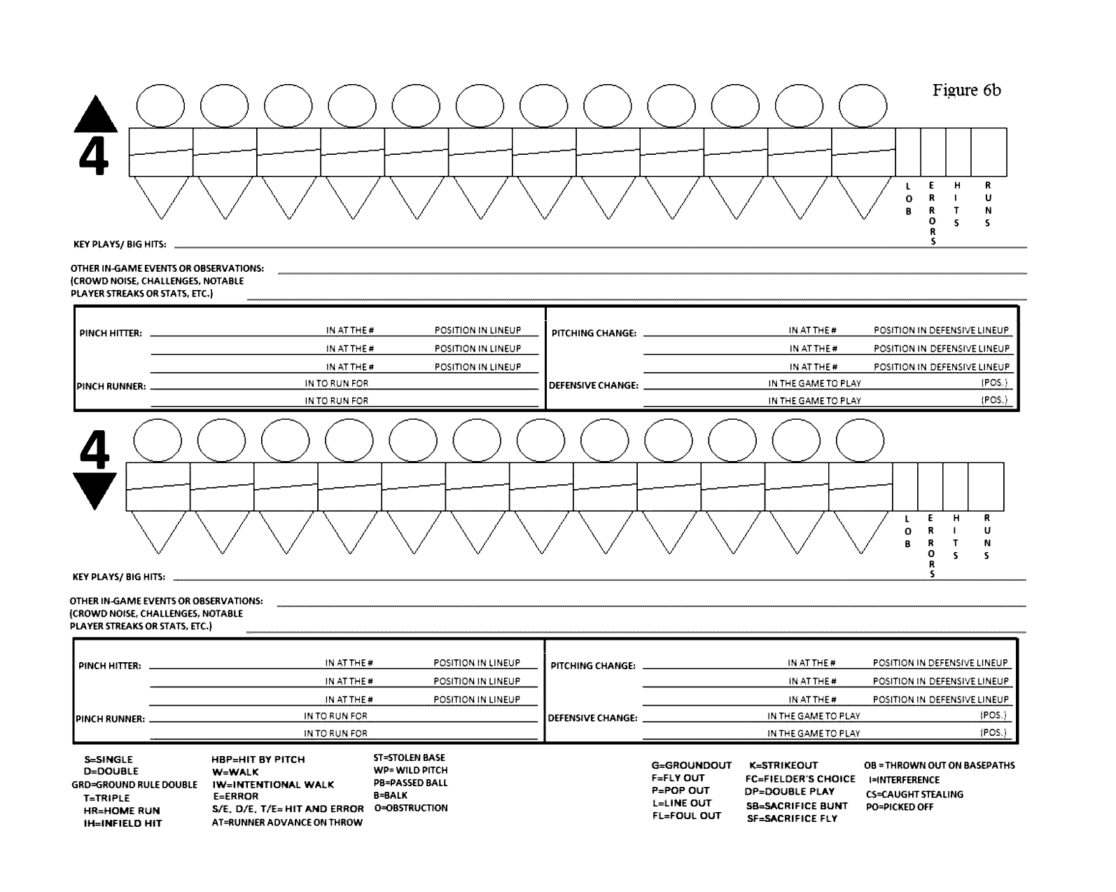

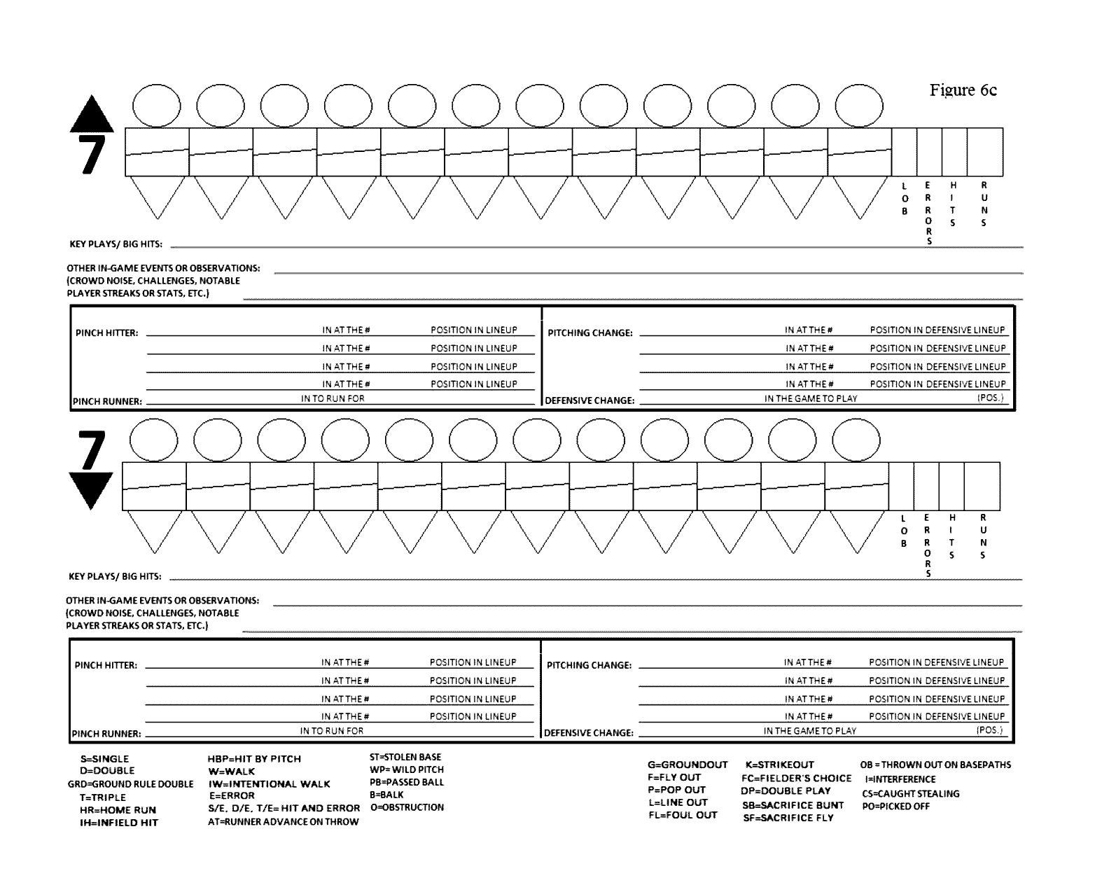

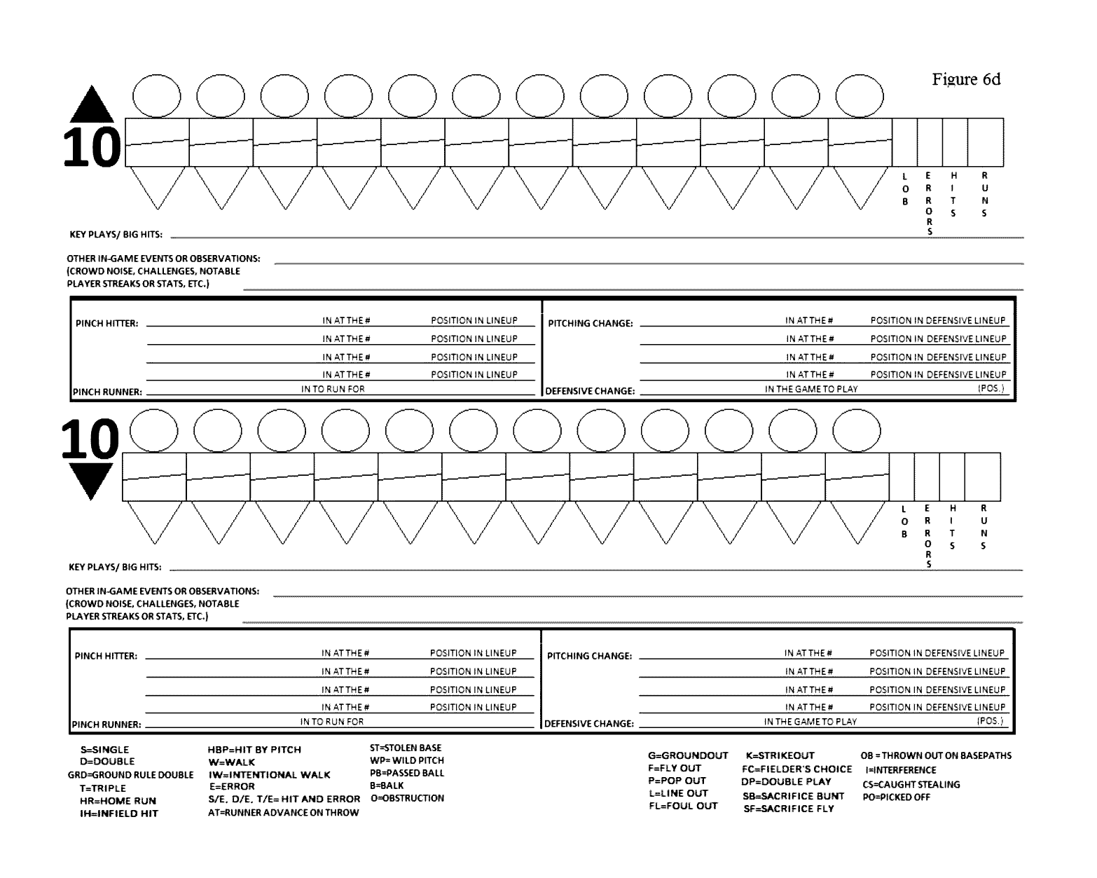

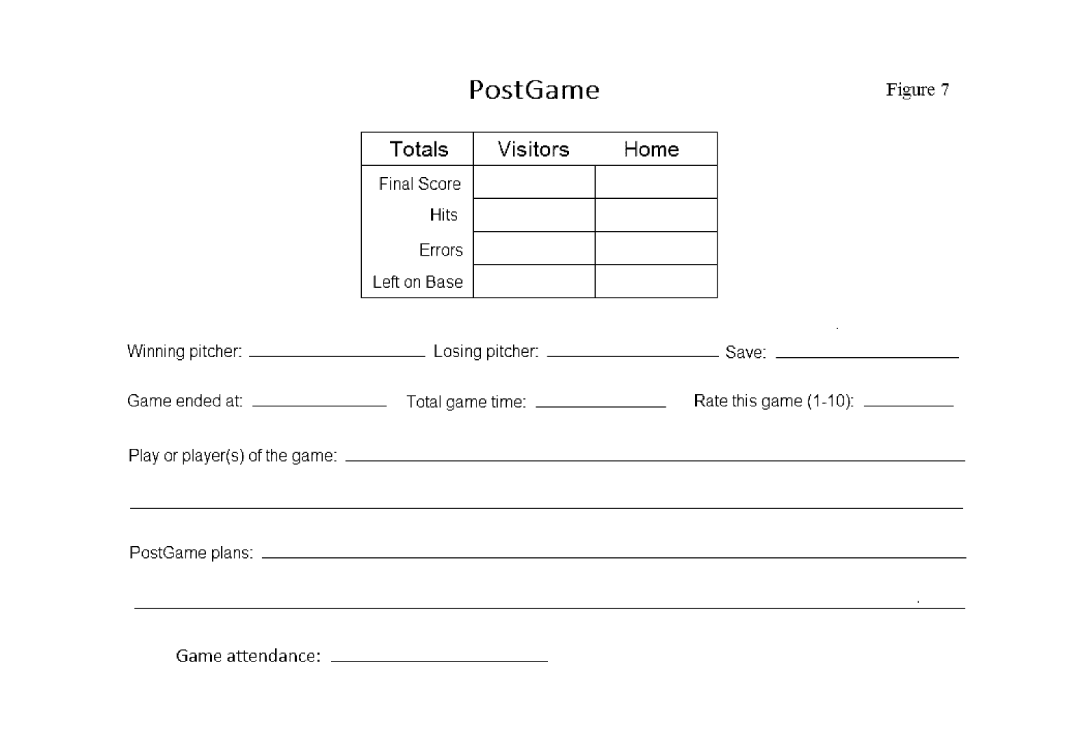

The “Innings” pages. This section contains the pages devoted to scoring the game, with one full inning per page. The top half of the inning is recorded on the top half of the page, and the bottom half of the inning is recorded on the bottom of the page, with the pages listed as innings 1 through 13. A full inning is recorded on the front of the page and the subsequent inning is recorded on the reverse (back) of the page throughout the GameKitt. The color scheme on the page borders changes every three innings The borders on innings pages 1 through 3, 4 through 6, 7 through 9, and 10 through 13 are all different colors relative to each other. The color scheme pertaining to the content area of the innings pages is as follows: The backgrounds of all areas of the page concerned with the offensive recordings during an inning are the same color, including the upper section of the at bat boxes (where a batter reaching or runner advancing is recorded), the Offensive Substitutions box heading, and the left, or “offensive” side of the Key abbreviations at the bottom of the page. Similarly, the backgrounds of all areas of the page concerned with the defensive recordings during the inning are shaded the same color, including the lower section of the at bat boxes (where outs are recorded), the Defensive Substitutions box heading, and the right, or “defensive” side of the Key abbreviations at the bottom of the page. Included on the “innings” pages is a horizontal row of 12 designated circles, divided rectangles and triangles (vertically aligned with each other) to record batter lineup positions (1 through 9), result of an at bat (one or more 1, 2, or 3 letter abbreviations as listed in the “Key”), and runs scored (if any) as the result of, or during an at bat. Also included are designated locations to record the end of inning statistics such as players left on base, defensive errors committed, hits, and runs scored during the half inning Also on the innings pages are designated areas to record any “Key Plays” or “Big Hits” that took place in the recorder's opinion during the half inning as well as other in-game observations made by the recorder. Additionally, there are designated offensive and defensive player substitution boxes where the recorder can indicate any player substitutions made by either team during the half inning At the bottom of the innings pages are the 1, 2, or 3 letter abbreviations repeated from the earlier “Key” page used to record any possible result of, or occurrence during an at bat in the at bat sections of the innings pages.

FIG. 6a: Innings pages (Innings 1, 2, and 3). These pages are identical to each other except for the “1”, “2”, or “3” inning designation. The top of the inning (visiting team batting) is recorded on the top of the page and the bottom of the inning (home team batting) is recorded on the bottom of the page.

FIG. 6b: Innings pages (Innings 4, 5, and 6). These pages are identical to each other except for the “4”, “5”, or “6” inning designation. These pages are different from the “1”, “2”, and “3” inning pages in that there is additional space to record player substitutions as substitutions normally occur more frequently as the game progresses into later innings Additionally, the page borders on these innings pages are a slightly different color.

FIG. 6c: Innings pages (Innings 7, 8, and 9). These pages are identical to each other except for the “7”, “8”, or “9” inning designation. These pages are different from the “4”, “5”, and “6” innings pages in that there is additional space to record player substitutions as substitutions normally occur more frequently as the game progresses into later innings. Additionally, the page borders on these innings pages are a slightly different color.

FIG. 6d: “Extra Innings” pages (Innings 10, 11, 12, and 13). These pages are identical to each other except for the “10”, “11”, “12”, or “13” inning designation. These pages are different from the “7”, “8”, and “9” innings pages only in that the border color for these pages is substantially different denoting their extra inning (post-regulation play) designation.

FIG. 7: The “PostGame” page. This page summarizes post game statistics including the final score, as well as the total number of hits, errors, and runners left on base by each team. Also are places to record the game's ending time, total game time, winning and losing pitchers, pitcher recording a save (if any), the “play or player of the game” in the recorder's opinion, an “excitement rating” on a scale of 1 to 10, total game attendance number (if known), as well as any postgame plans or events attended by the recorder. *This final “PostGame” section can be filled out at a later time at the recorder's discretion if so desired.

### DETAILED DESCRIPTION OF THE INVENTION

The function of the GameKitt is to retain a detailed record of a day at the ballpark. More personal and substantive but less technical and specific than the traditional scorecard, it is intended to record all of the circumstances, conditions, personal observations and events involved with or relating to the experience of attending a professional (major or minor league) baseball game. The purpose of the GameKitt is not only to retain a play-by-play account of the game, but also to keep a more comprehensive, meaningful record of the entire experience that can later be referred to for either historic or nostalgic purposes. The GameKitt is a spiral bound “notebook” style flip-through with a front and back cover. The content pages are standard 8.5×11 inch medium to heavy stock paper. It is bound on the long side (top) with horizontal content. It can be generic or team specific. If it is team specific, the color scheme and content will reflect the home team.

The first item contained within the GameKitt is a plastic transparent sleeve that is used to retain the recorder's ticket stub(s), as well as any and all game related paraphernalia such as parking passes or purchase receipts, stadium handouts, photos taken at the game, etc. The insert edge of the sleeve is the spiral bind edge inside the open GameKitt.

The first page of the GameKitt is the “Welcome” page. A welcoming statement followed by the intended function and purpose, as well as a brief instructive overview of the GameKitt is stated on this page for the benefit of the recorder.

The first substantive page of the GameKitt is the “GameDay” page. This page includes designated areas to record pregame information and observations including: date and time, game location (stadium name, city and state or province), starting time of the game, family or acquaintances also in attendance, weather conditions, game number attended (during the current season) and seat information and rating, as well as any otherwise relevant information concerning the game (such as promotional dates, playoff implications, important home games, or otherwise momentous games for team, individual player, or even for the recorded himself or herself).

The next page is the “PreGame” page. This page includes places to record the contending teams (if the GameKitt is generic), or the opposing team (if the GameKitt is home team specific), the starting lineups (including player names, field positions, batting orientation (right or left), and batting order) and team managers. *The “Welcome”, “GameDay”, and “PreGame” pages all have similarly colored page borders.

Following the pregame information page is a “Key” page listing the simple abbreviations (consisting of 1, 2, or 3 letters) to use in the GameKitt innings pages that follow to record any possible result of, or occurrence during an at bat. Included on the Key page is a sample “inning” and instructions on how and when to fill in the lineup positions, at bat, end of inning statistics and offensive and defensive player substitutions sections included on the innings pages.

The next section contains the innings pages devoted to scoring the game, with one full inning per page. The top half of the inning (visiting team batting) is recorded on the top half of the page, and the bottom half of the inning (home team batting) is recorded on the bottom of the page, with the pages listed as innings 1 through 13. A full inning is recorded on the front of the page and the subsequent inning is recorded on the reverse (back) of the page throughout the GameKitt. (1) The color scheme on the page borders changes every three innings The borders on innings pages 1 through 3, 4 through 6, 7 through 9, and 10 through 13 are all different colors relative to each other. *Drawings of innings pages 2 and 3, 5 and 6, 8 and 9, and 11, 12, and 13have not been included in the drawings section of the GameKitt application submission as these pages are identical to innings pages 1, 4, 7, and 10 respectively with the exception of the inning number designation. The color scheme pertaining to the content area of the innings pages is as follows: The backgrounds of all areas of the page concerned with the offensive recordings during an inning are the same color, including the upper section of the at bat boxes (where a batter reaching or runner advancing is recorded), the Offensive Substitutions box heading, and the left, or “offensive” side of the Key abbreviations at the bottom of the page. Similarly, the backgrounds of all areas of the page concerned with the defensive recordings during the inning are shaded the same color, including the lower section of the at bat boxes (where outs are recorded), the Defensive Substitutions box heading, and the right, or “defensive” side of the Key abbreviations at the bottom of the page. *This aspect of the GameKitt may be difficult to discern by the USPTO reviewer as submitted drawings of the invention are normally only accepted in black and white. Included on the “innings” pages is a horizontal row of 12 designated circles, divided rectangles and triangles (vertically aligned with each other) to record batter lineup positions (1 through 9), result of an at bat (one or more 1, 2, or 3 letter abbreviations as listed in the “Key”), and runs scored (if any) as the result of, or during an at bat. Also included are designated locations to record the end of inning statistics such as players left on base, defensive errors committed, hits, and runs scored during the half inning Also on the innings pages are designated areas to record any “Key Plays” or “Big Hits” that took place in the recorder's opinion during the half inning as well as in-game observations made by the recorder. Additionally, there are designated offensive and defensive player substitution boxes where the recorder can indicate any player substitutions made by either team during the half inning At the bottom of the innings pages are the 1, 2, or 3 letter abbreviations repeated from the earlier “Key” page used to record any possible result of, or occurrence during an at bat in the at bat sections of the innings pages.

After the innings pages, there is a “PostGame” section summarizing postgame statistics including the final score, as well as the total number of hits, errors, and runners left on base by each team. Also are places to record the game's ending time, total game time, winning and losing pitchers, pitcher recording a save (if any), the “play or player of the game” in the recorder's opinion, an “excitement rating” on a scale of 1 to 10, total game attendance number (if known), as well as any postgame plans or events attended by the recorder *This final “PostGame” section can be filled out at a later time at the recorder's discretion if so desired. The “PostGame” page has a uniquely colored page border that is different than the rest of the GameKitt pages.

Finally, the GameKitt comes with a pre sharpened standard #2 graphite pencil used to fill out and record the required information within the GameKitt.

(1) For the purpose of initial design and introduction of the GameKitt, all pages within the GameKitt are double sided with content on front and back. However, future designs contingent upon adoption of the GameKitt may include game content on the front of the pages with advertisement or team or organization specific information included on the reverse (back) of the pages. This scenario would be likely if the GameKitt were adopted and used in a team specific manner. *Additionally, pending adoption and production of the GameKitt, a supporting website will be launched to further introduce, explain and supplement to GameKitt.

1. A baseball scorekeeping and recording system which is rectangular in shape and has a front and back cover which are different from the sheets within the device that serve as the functional body of the device, between which is included a transparent plastic receptacle sleeve which is open at one side for retaining baseball game ticket stubs, photographs, printed stadium handouts, or other printed fan paraphernalia.
A baseball scorekeeping and recording system which is rectangular in shape and includes a “Welcome” sheet with text explaining the purpose and intent of the device and welcoming the user to the device.
A baseball scorekeeping and recording system which is rectangular in shape and includes a “GameDay” sheet with specific questions/observations about the game in question listed as Date, Current Time, Stadium, City/State, Game Start Time, Game Number (attended this season), I am at the Game With, The Weather Is, Approximate Temperature, Section, Row, Seat, Rate This Seat (1-10), Notable Game Information (playoff implications, team standings, divisional play, promotional giveaway, or personal importance for the user), with horizontal lines following the questions/observations for written responses by the user.
A baseball scorekeeping and recording system which is rectangular in shape and includes a “PreGame” sheet on which in printed vertical Visitors and Home columns adjacent to one another, with 9 horizontal rows numbered 1 through 9 on both Visitors and Home sides, and which have diagonal slashes within the rows to separate the recording of the player name, player field positions, and right handed or left handed player designation, and two additional divided rows under the player rows which are not numbered but are for the recording of designated hitters (for American League games) and team managers by the user.
A baseball scorekeeping and recording system which is rectangular in shape and includes a “Key” sheet on which is printed a sample half inning and instructions on how the user shall properly score a baseball game using the device, and which has sets of instructions for the user and lines originating from each instruction set to specific steps of the scorekeeping process printed on the sheet.
A baseball scorekeeping and recording system which is rectangular in shape and includes 3 sheets for innings 1, 2, and 3 which each have 2 horizontal rows of 12 “At-Bat” boxes (one row designated for the top of the inning and one row designated for the bottom of the inning) with a diagonal slash separating the top half of each at-bat box from the lower half of the box for recording the result of the at-bat (with a player reaching base recorded above the dividing slash and a player making an out recorded below the dividing slash), and which includes a circle above each box to record the batting player's position in the lineup, and which includes a triangle under each box to record the number of runs scored as a result of the at-bat, and which includes 4 empty boxes at the end of the horizontal row of at-bat boxes to record the runs, hits, errors, and runners left on base during the half inning, and which has in front of each horizontal row of at-bat boxes an inning number and upper or lower pointing triangles designating top or bottom half designation of the inning,
under each of which are 2 questions/observations about the half inning listed as “Key Plays/Big Hits” and “Other in-game events or observations such as crowd noise, manager challenges, notable player streaks or stats, etc.”, adjacent to which are 3 horizontal lines designated for responses to these questions/observations,
under each of which is a horizontally rectangular box divided vertically in the middle, with 4 horizontal lines on each side of the box to record pinch-hitters and pinch-runners (offensive substitutions—left box), what batting position they are entering in the line-up and what player they are replacing, pitching changes and defensive changes (defensive substitutions—right box), what position in the line-up they are entering and what position in the field they are taking,
under which is an area of listed abbreviations used for the recording of results of an at-bat, and which is divided by a diagonal line dividing abbreviations for a player reaching base from abbreviations for a player making an out and which are designated as follows;
S=Single, D=Double, GRD=Ground Rule Double, T=Triple, HR=Home Run, IH=Infield Hit, HBP=Hit By Pitch, W=Walk, IW=Intentional Walk, E=Error, S/E, DIE, or T/E=Hit and an Error, AT=Runner Advance on Throw, ST=Stolen Base, WP=Wild Pitch, PB=Passed Ball, B=Balk, O=Obstruction, and
G=Ground Out, F=Fly Out, P=Pop Out, L=Line Out, FL=Foul Out, K=Strikeout, FC=Fielder's Choice, DP=Double Play, SB=Sacrifice Bunt, SF=Sacrifice Fly, OB=Thrown Out on Base paths, I=Interference, CS=Caught Stealing, and PO=Picked Off.
A baseball scorekeeping and recording system which is rectangular in shape and includes 3 sheets for innings 4, 5, and 6 that have color schemes slightly different than the color schemes for inning sheets 1, 2, and 3, each of which have 2 horizontal rows of 12 “At-Bat” boxes (one row designated for the top of the inning and one row designated for the bottom of the inning) with a diagonal slash separating the top half of each at-bat box from the lower half of the box for recording the result of the at-bat (with a player reaching base recorded above the dividing slash and a player making an out recorded below the dividing slash), and which includes a circle above each box to record the batting player's position in the lineup, and which includes a triangle under each box to record the number of runs scored as a result of the at-bat, and which includes 4 empty boxes at the end of the horizontal row of at-bat boxes to record the runs, hits, errors, and runners left on base during the half inning, and which has in front of each horizontal row of at-bat boxes an inning number and upper or lower pointing triangles designating top or bottom half designation of the inning,
under each of which are 2 questions/observations about the half inning listed as “Key Plays/Big Hits” and “Other in-game events or observations such as crowd noise, manager challenges, notable player streaks or stats, etc.”, adjacent to which are 3 horizontal lines designated for responses to these questions/observations,
under each of which is a horizontally rectangular box divided vertically in the middle, with 5 horizontal lines on each side of the box to record pinch-hitters and pinch-runners (offensive substitutions—left box), what batting position they are entering in the line-up and what player they are replacing, pitching changes and defensive changes (defensive substitutions—right box), what position in the line-up they are entering and what position in the field they are taking,
under which is an area of abbreviations used for the recording of results of an at-bat, and which is divided by a diagonal line dividing abbreviations for a player reaching base from abbreviations for a player making an out and which are designated as follows;
S=Single, D=Double, GRD=Ground Rule Double, T=Triple, HR=Home Run, IH=Infield Hit, HBP=Hit By Pitch, W=Walk, IW=Intentional Walk, E=Error, S/E, DIE, or T/E=Hit and an Error, AT=Runner Advance on Throw, ST=Stolen Base, WP=Wild Pitch, PB=Passed Ball, B=Balk, O=Obstruction, and
G=Ground Out, F=Fly Out, P=Pop Out, L=Line Out, FL=Foul Out, K=Strikeout, FC=Fielder's Choice, DP=Double Play, SB=Sacrifice Bunt, SF=Sacrifice Fly, OB=Thrown Out on Base paths, I=Interference, CS=Caught Stealing, and PO=Picked Off.
A baseball scorekeeping and recording system which is rectangular in shape and includes 3 sheets for innings 7, 8, and 9 that have color schemes slightly different than the color schemes for inning sheets 1, 2, and 3, or inning sheets 4, 5, and 6, each of which have 2 horizontal rows of 12 “At-Bat” boxes (one row designated for the top of the inning and one row designated for the bottom of the inning) with a diagonal slash separating the top half of each at-bat box from the lower half of the box for recording the result of the at-bat (with a player reaching base recorded above the dividing slash and a player making an out recorded below the dividing slash), and which includes a circle above each box to record the batting player's position in the lineup, and which includes a triangle under each box to record the number of runs scored as a result of the at-bat, and which includes 4 empty boxes at the end of the horizontal row of at-bat boxes to record the runs, hits, errors, and runners left on base during the half inning, and which has in front of each horizontal row of at-bat boxes an inning number and upper or lower pointing triangles designating top or bottom half designation of the inning,
under each of which are 2 questions/observations about the half inning listed as “Key Plays/Big Hits” and “Other in-game events or observations such as crowd noise, manager challenges, notable player streaks or stats, etc.”, adjacent to which are 3 horizontal lines designated for responses to these questions/observations,
under each of which is a horizontally rectangular box divided vertically in the middle, with 5 horizontal lines on each side of the box to record pinch-hitters and pinch-runners (offensive substitutions—left box), what batting position they are entering in the line-up and what player they are replacing, pitching changes and defensive changes (defensive substitutions—right box), what position in the line-up they are entering and what position in the field they are taking,
under which is an area of abbreviations used for the recording of results of an at-bat, and which is divided by a diagonal line dividing abbreviations for a player reaching base from abbreviations for a player making an out and which are designated as follows;
S=Single, D=Double, GRD=Ground Rule Double, T=Triple, HR=Home Run, IH=Infield Hit, HBP=Hit By Pitch, W=Walk, IW=Intentional Walk, E=Error, S/E, DIE, or T/E=Hit and an Error, AT=Runner Advance on Throw, ST=Stolen Base, WP=Wild Pitch, PB=Passed Ball, B=Balk, O=Obstruction, and
G=Ground Out, F=Fly Out, P=Pop Out, L=Line Out, FL=Foul Out, K=Strikeout, FC=Fielder's Choice, DP=Double Play, SB=Sacrifice Bunt, SF=Sacrifice Fly, OB=Thrown Out on Base paths, I=Interference, CS=Caught Stealing, and PO=Picked Off.
A baseball scorekeeping and recording system which is rectangular in shape and includes 3 sheets for innings 10, 11, and 12 (extra innings if necessary) that have color schemes slightly different than the color schemes for inning sheets 1, 2, and 3, innings sheets 4, 5, and 6, and innings sheets 7, 8, and 9, each of which have 2 horizontal rows of 12 “At-Bat” boxes (one row designated for the top of the inning and one row designated for the bottom of the inning) with a diagonal slash separating the top half of each at-bat box from the lower half of the box for recording the result of the at-bat (with a player reaching base recorded above the dividing slash and a player making an out recorded below the dividing slash), and which includes a circle above each box to record the batting player's position in the lineup, and which includes a triangle under each box to record the number of runs scored as a result of the at-bat, and which includes 4 empty boxes at the end of the horizontal row of at-bat boxes to record the runs, hits, errors, and runners left on base during the half inning, and which has in front of each horizontal row of at-bat boxes an inning number and upper or lower pointing triangles designating top or bottom half designation of the inning,
under each of which are 2 questions/observations about the half inning listed as “Key Plays/Big Hits” and “Other in-game events or observations such as crowd noise, manager challenges, notable player streaks or stats, etc.”, adjacent to which are 3 horizontal lines designated for responses to these questions/observations,
under each of which is a horizontally rectangular box divided vertically in the middle, with 5 horizontal lines on each side of the box to record pinch-hitters and pinch-runners (offensive substitutions—left box), what batting position they are entering in the line-up and what player they are replacing, pitching changes and defensive changes (defensive substitutions—right box), what position in the line-up they are entering and what position in the field they are taking,
under which is an area of abbreviations used for the recording of results of an at-bat, and which is divided by a diagonal line dividing abbreviations for a player reaching base from abbreviations for a player making an out and which are designated as follows;
S=Single, D=Double, GRD=Ground Rule Double, T=Triple, HR=Home Run, IH=Infield Hit, HBP=Hit By Pitch, W=Walk, IW=Intentional Walk, E=Error, S/E, DIE, or T/E=Hit and an Error, AT=Runner Advance on Throw, ST=Stolen Base, WP=Wild Pitch, PB=Passed Ball, B=Balk, O=Obstruction, and
G=Ground Out, F=Fly Out, P=Pop Out, L=Line Out, FL=Foul Out, K=Strikeout, FC=Fielder's Choice, DP=Double Play, SB=Sacrifice Bunt, SF=Sacrifice Fly, OB=Thrown Out on Base paths, I=Interference, CS=Caught Stealing, and PO=Picked Off.
A baseball scorekeeping and recording system which is rectangular in shape and includes a “PostGame” sheet on which is printed a box that is divided horizontally and vertically with designated areas for Final Score, Hits, Errors, and Left on Base for each team that played in the game, under which are questions/observations about the game which are listed as Winning Pitcher, Losing Picher, Save, Game Ended At, Total Game Time, Rate this Game (1-10), Play or Player(s) of the Game, Post Game Plans, and Game Attendance, adjacent to which are horizontal lines for responses to these questions/observations.
